(19) United States
(12) Patent Application Publication
(10) Pub. No.: US 2010/0278981 A1
(43) Pub. Date: Nov. 4, 2010

(54) Meal Replacement and Appetite Control/ Diet System

(76) Inventor: Gary Ervin, Naples, FL (US)

Correspondence Address: Gary Ervin, 3431 8th Ave S.E., Naples, FL, 34117, US

(21) Appl. No.: 12/765,738

(22) Filed: Apr. 22, 2010

Related U.S. Application Data
(60) Provisional application No. 61/171,814, filed on Apr. 22, 2009.

(51) Int. Cl. A23L 1/29; A23L 2/52; A23L 1/035; A23L 1/05; A23G 1/32; A23G 3/36; A23L 1/27

(52) U.S. Cl. 426/250; 426/541; 426/545

(57) ABSTRACT

The present invention provides a composition of nutritive based ingredients that together provide a source of balanced and provides the ability to control food cravings, increase satiety, promote a feeling of fullness and provide a user a method to maintain a healthy weight and or achieve weight loss. This composition of ingredients includes a chocolate or caramel flavored confection component, a high protein component, a fiber blend component, an edible oil component, an antioxidant component from natural occurring sources, a supplement component that can provide specific health benefits as well as a balanced group of vitamins and minerals. The composition of ingredients can be delivered in a variety of food platforms. A functional food confectionery is a preferred platform for our invention delivery system. Portion control bars and/or bars that have pre-determined break points that control portion size and portioned squares or other shapes would be the preferred product structure. A complete weight loss and weight maintenance methodology, including use instructions for incorporating the products within the daily diet is identified. Methods of manufacturing and compositions are also included.

The present application claims the benefit of U.S. Provisional Application Ser. No.: 61/171,814 filed Apr. 22^{nd}, 2009.

### FIELD OF THE INVENTION

### Background of the Invention

The present invention relates generally to ingestible chocolate or caramel flavored confectionery compositions having nutritive based ingredients that together provide a source of balance nutrition and the ability to control food cravings, increase satiety, promote a feeling of fullness and provide a user a method to achieve weight loss and or maintain a healthy weight. Our invention utilizes a group of nutraceutical based ingredients to provide users a method to gain control of his or her eating patterns and provides a structured method of delivery that helps control food cravings and which levels the peaks and valleys of hunger that otherwise normally occur over the course of the day.

Maintaining a healthy diet has become much more difficult over the last decade as consumers today are bombarded by marketers offering high carbohydrate sodas, drinks, snack foods, and confectionery products that have little to no nutritive benefits. Packaging has become oversize, supersize, value size, and many beverages and snack foods now provide 2 to 4 or more servings per container. Consumers are eating these large serving sizes more than ever. Fast food chains, convenience stores, coffee shops, and retail locations that sell sodas, snacks, and confectionery products are on every corner. Consumers are giving in more often to the temptation and eating too many calories daily. These and other factors are contributing to a surge in Americans and global consumers becoming overweight. The link below to ongoing research by the USDA identifies that 31% of Americans are obese and consumers are eating as high as 4,000 calories a day in many consumers' long-term diets.

http://www.nmcphc.ed.navy.mil/downloads/healthyliv/nutrition/articles data/patterns caloric intake bmi.pdf

Our invention utilizes a portion controlled structure of having around 15 gram squares and 1.6 ounce bars that have a group of ingredients that give the consumer a range of nutrition that combats different aspects of nutrition necessary to lose weight and/or help maintain a healthy weight. A recommended usage system is provided to aid the dieter in managing hunger and food cravings over the course of an entire day and an important aspect of our invention is that it promotes a level glycemic response over an entire day when the recommended daily eating schedule and plan are incorporated into a typical daily diet.

Most current diet plans recommend calorie restriction as the means to achieve weight loss and such plans often require a complete restructuring of eating habits. These diets are often effective in achieving weight loss in the short term, but dieters have a difficult time keeping weight off long term because they simply do not like the recommended foods or because they continuously suffer from hunger, and so they revert back to their previous eating habits. Our invention offers a revolutionary and realistic alternative, which is natural hunger control through daily eating of our controlled portion.

### Nutritional Confections

A daily regimen of eating three to five, 12-15 gram portions of the product over the course of the day serves as a weight loss aid.
Reduces food cravings and suppresses the appetite.
Balances/stabilizes blood sugar levels so that one does not experience peaks and valleys in energy levels that lead to food cravings and overeating.
Improves metabolism and provides increased energy levels. This tends to make people more active so they naturally burn more calories.
People lose weight by simply eating less based on a reduced craving for food and a healthy boost in energy. No fundamental changes to person's food choices are required.
No lifestyle changes are required for success. Although, exercise should be part of a healthy weight loss and weight maintenance program.
   1. Description of Related Art by product type

U.S. Pat. No. 6,207,638 to Portman March 2001 describes a composition that enhances and extends satiety. This patented invention's composition contains protein, long chain fatty acids, calcium, soluble and insoluble fibers that promotes satiety. They say this composition can be contained in a composition that has 80 calories and that can be eaten prior to a meal. While there are some similarities between Portman's patent and our invention we have a specific group of nutritive ingredients that goes beyond Portman that contribute to our inventions ability to control food cravings, increase satiety, and help users control their eating habits over the whole day. Portman has only long chain fatty acids as part of its invention compared to our invention that has a nearly perfect balance of medium chain triglycerides and long chain triglycerides contained in the coconut oil and other edible oils that have a good balance of monounsaturated and polyunsaturated fat. The specific characteristic of this balance of medium chain fatty acids and long chain fatty acids in our invention gives the user immediate energy and a supply of energy for a longer time period so that users have a balanced energy level throughout the day compared to Portman that only has triglycerides that supply energy over a longer period.

We also have specific platforms that include nutritionally driven chocolate and caramel flavored confection formulas as a preferred delivery method for our diet and weight loss system. We are able to provide a well balanced group of nutrients that has superior taste versus other diet based meal and diet snack based offerings in the market place. By having this complete group of nutrients within a great tasting chocolate and caramel platform delivery method individuals can have satisfaction and improved satiety when eating our portion controlled squares and bars. Because of this superior taste of our delivery chocolate and caramel delivery method consumers easily can incorporate our strategy of daily eating 5 12-15 gram squares that help control food cravings, increase satiety, and promote the feeling of fullness that allows consumers to sustain our diet and weight loss system. This specific methodology of a schedule for eating the portion controlled squares and bars throughout the day leads to hunger control and thus supports weight loss and/or weight management compared to Portman.

U.S. Pat. No. 7,618,648 to Gerhardt, et. al November 2009 describes a whey protein hydrolysate which stimulates the cellular release of satiety peptides within the human body. They also describe edible compositions that can be used to control body weight and have beneficial effects on satiety. This invention talks about these edible compositions used in a weight loss plan or in meal replacement products. While Gerhardt, et. al invention describes compositions that improve satiety and gives types of foods that this composition can be used in the invention only targets one aspect of maintaining a healthy weight or losing weight. Gerhardt, et. al has no discussion of controlling food cravings or the concept of preventing overeating. Science has conclusively proven that consumers get food cravings based on emotional attachments to certain types of foods. Chocolate containing foods are known to be one of the largest categories of foods consumers crave. Our invention specifically addresses food cravings as one of the targeted primary issues within our weight loss and healthy weight maintenance program. Our invention has a specified plan of eating the portion control nutritive ingredient based chocolate or caramel flavored confections throughout the day that helps to prevent food cravings. A portion controlled square can satisfy the food craving and effectively treat the craving or desire for foods. Also our invention has a specific mechanism for preventing overeating. Gerhardt doesn't address the issue of overeating at all in their patent. Recent government studies above shows that consumer's diets follow a peaks and valley calorie consumption during a whole month. Many days consumer's calorie intakes are at a recommended level during the month and then they will have days when their calorie intake spikes to over twice recommended levels. This peaks and valleys calorie intake phenomenon comes from overeating on those occasions when dieters are unable to curb their appetites. Our invention differs from Gerhardt in that ours addresses the aspect of overeating and we specifically suggest that users consume a “rescue squares” anytime they will be put in a situation that may lead to overeating, such as when they “go out” for dinner.

U.S. Pat. No. 7,550,161 to Wenniger describes a nutritional weight loss agent and method for providing the agent. This invention contains a group of supplement ingredients including Guarana , CitriMax.RTM, and L-tyrosine. This group of supplements together acts as an appetite suppressant. Wenniger suggests putting the composition into a confection like a lollipop. While controlling a user's appetite is an important aspect of weight loss Wenniger doesn't include any discussion of controlling food cravings or increasing satiety or promoting the feeling of being full. Appetite suppression alone doesn't give the consumer a balance group of nutrition that is necessary to provide complete diet and weight loss control. Appetite suppression isn't a long term strategy to maintaining a healthy weight or for a sustainable weight loss system. Our invention provides the complete nutrition that works to satisfy all aspects of a healthy diet and provides hunger control , improved satiety, feeling of being full or satisfied and a structured plan to accomplish the users goal of long-term healthy weight maintenance or weight loss.

### Low Fat vs Balanced Fats

Much work has been done to create low fat or reduced fat standardized chocolate or non-standardized chocolate compositions. U.S. Pat. No. 5,464,649 to St. John, et. al. discloses a lowfat chocolate confection that can be made with as low as 25% total fat having flow properties suitable for molding, extruding or enrobing operations. Prior to 1980 the consensus in the medical community was that low fat was the most important aspect of the diet with respect to improved heart health and in order to maintain a healthy weight and lose weight.

Pre 1980 dietary guidelines led producers and consumers to believe that a low fat diet was the way to maintain a healthy weight and/or to lose weight. Fat free and low fat foods were marketed as having benefits that help consumers control their weight. A problem with fat free and low fat foods is that they generally are devoid of beneficial nutrients that are necessary for a complete and healthy diet. The link below discusses the Harvard School of Public Health study that was the largest food study ever created to examine how certain fats affect consumer's long term health. The conclusion is that consumer's need to get more of the “good unsaturated fats” (including monounsaturated and polyunsaturated fats) and less of the saturated fats in their diets like milk fat and animal fat that comes from beef and other meat sources. The current invention creates chocolate and caramel flavored based health driven platforms for our diet and weight loss system that have a balance of saturated fats, monounsaturated fats and polyunsaturated fats. This balance of dietary fats between ones that provide immediate energy like cocoa seed butter and coconut oil and the monounsaturated and polyunsaturated oils including the essential fatty acids Omega 6 and Omega 3 that provide longer term release of energy gives our invention the ability to satisfy hunger and control appetite throughout the day. Through continued scientific study it has been found and proven that it is not the amount of fat in the diet per se that is the critical aspect for reducing health related issues like; coronary heart disease, diabetes, obesity, overweight, and other health issues, but rather the types of fats and the balance of those fats which are included in foods. (see

http://www.hsph.harvard.edu/nutritionsource/what-should-you-eat/fats-full-story/index.html)

Many consumers were led to believe that a low fat diet was the way to maintain a healthy weight and to lose weight if you were on a diet. Fat free and low fat foods were being marketed in many categories within retail grocery as having benefits that help consumers control their weight. The problem with fat free and low fat foods is that they generally are devoid of beneficial nutrients that consumers need to support a healthy diet. The link below discusses the Harvard School of Public Health study that was the largest food study ever created to examine how certain fats affect consumer's long term health. The conclusion is that consumers need to get more of the “good unsaturated fats” (unsaturated fats including monounsaturated and polyunsaturated fats) and less of the saturated fats in their diets like milk fat and animal fat that comes from beef and other meet sources. The current invention creates chocolate and caramel flavored based health driven platforms for our diet and weight loss system that have a balance of saturated that providing beneficial monounsaturated and polyunsaturated fat content. Our invention also covers a composition that includes a group of edible oils that along with the other components can give a wider variety of foods a perfect balance of dietary fats. This balance of dietary fats including the essential fatty acids Omega 6 and Omega 3 provide balance release of energy in the short term through the coconut oil component and long term energy that comes from the unsaturated fats that the body processes into energy slower.

http://www.hsph.harvard.edu/nutritionsource/what-should-you-eat/fats-full-story/index.html

This report is based on the largest study ever undertaken on the effect of reducing saturated fats and replacing them with unsaturated fats including monounsaturated and polyunsaturated fats. The study concluded that many of the major health issues facing consumers today can be directly attributed to consumption of high levels of saturated fat, partially hydrogenated, fully hydrogenated, and Trans fats. The study examined the effect of replacing such saturated fats with healthier monounsaturated and polyunsaturated fats in the diet and how certain saturated fats like those found in coconut are significantly better for you than saturated fat found in milk and butter. The study concluded that this had a significant effect on reducing the risks of developing chronic health conditions including cardiovascular disease and coronary heart disease.

### SUMMARY OF THE INVENTION

It is, therefore, an object of this invention to provide an excellent tasting health driven composition chocolate or caramel flavored confection as well as a composition that can be added to a wide variety of foods that provides balanced nutrition and appetite control benefits. This healthy chocolate, caramel flavored confection or additional food containing this composition can control food cravings, increase satiety, increase the feeling of fullness, and thus reduce overeating. The ability to control food cravings, increase satiety, increase the feeling of fullness, and help in reducing instances of overeating can be accomplished through novel compositions that utilize a balance of nutrition including a high protein component, an antioxidant component from natural occurring sources, a supplement component that can provide specific health benefits as well as a balanced group of vitamins and minerals.

It is an object of this invention to provide a level of protein within the compositions to provide satisfaction and help prevent food cravings. Protein also adds to the feeling of satisfaction in eating and increases satiety. Protein is one of the three core nutritive ingredients within our composition that contribute powerful healthy benefits to successful weight maintenance and weight loss program. It is another object of this invention to provide a fiber component to the composition that has multiple health benefits. Our formulations have a balance group of bulk forming fiber and non-bulk forming fiber within our composition. Fiber helps balance a user's blood sugar over the whole day when eaten throughout the day as our invention suggests. Balanced blood sugar levels even out the highs and lows in blood sugar and users accordingly do not experience the strong food cravings that occur when blood sugar levels fall to low levels as does when individuals don't eat nutritious food throughout the day as our program suggests. This is important because such cravings can result in the consumption of abnormally high levels of calorie intake. The bulk forming fiber component of our formulations supports the feeling of fullness because it swells in the digestion system and makes one feel full over a sustained period of time. Fiber also increases the speed of transit through the digestion system and this helps to prevent absorption of calories. It is another object of the present invention to create chocolate and caramel flavored confection, and other foods based on a nutritional composition that can provide a balance of dietary fats including saturated fats, polyunsaturated fats, and monounsaturated fats including beneficial Omega 6 and Omega 3 fatty acids. It is another object of this invention to have a antioxidant flavor profile that gives the caramel flavored confection a specific unique novel flavor that comes from the synergy of coconut oil, vanilla powder, and the caramelization process flavors. The flavor profile thus created is a completely unique taste profile vs. all other caramel flavored confections currently in the market place.

It is another object of this invention to provide a balance of edible oils within the compositions that promote healthy weight maintenance and weight loss. A good balance of dietary fats is proven to be healthy in the diet. As discussed above consumers today eat too much saturated fat and lack the unsaturated fats in their diet that are necessary for a healthy lifestyle. Our invention gives the user a balance between saturated, monounsaturated, and polyunsaturated fats. We have saturated fats that come from cocoa seed butter and coconut oil in the chocolate platform technology and primarily from coconut oil in the caramel flavored confection platform and in the nutritional composition that can be added to foods and beverages. A large part of the saturated fat within our compositions comes from medium chain triglycerides. The medium chain triglycerides are processed immediately into energy within the human body. This release of immediate energy promotes the feeling of satiety or satisfaction when eating our compositions in the human body. The other saturated fats within coconut and the group of highly unsaturated fats found within the edible oil component are processed into energy slower and give the user a long acting boost of energy and promote satiety over a long period that can curb food cravings. This balance between energy released immediately and energy released over a longer period is a critical aspect of our invention that utilizes balanced nutrition to support reduction of food cravings, increase satiety, and promotion of fullness. The balance of dietary fats also contributes to a balancing of blood sugars which provide benefits as described above.

It is another object of our invention to provide antioxidants which offer protection from free radicals. The USDA and American Heart Association now suggest some form of cardiovascular exercise daily and some anaerobic exercise several times weekly. This exercise causes free radical to develop in the body and antioxidants can help neutralize these free radicals from damaging our bodies. When one reduces body fat, through diet or exercise, the toxins that were stored in the fat cells are released into the system and antioxidants can help combat the negative affect these toxins can have on the body. That is why many people feel sluggish and almost sick at first when they begin a diet program. Oxidation is the process of breaking down these fat cells and this oxidation process can be controlled with antioxidants. Also antioxidants can improve how individuals feel throughout the weight loss process and into maintenance of a healthy weight into the future. Our invention has a specific antioxidant component plus coconut oil is a potent antioxidant and the cocoa found with the chocolate based platform delivery method contains beneficial antioxidants.

Finally, our invention contains a supplement component that adds beneficial nutrients to the complete nutrition based healthy weight maintenance and weight loss compositions. Within the chocolate platform we add Chia seeds that are almost a perfect superfood.

Chia seeds have potent antioxidants, 25% fiber, 20% protein, and 35% healthy fats including a high percentage of Omega 3 ALA's as well as beneficial nutrients and vitamins and minerals. Chia seeds contribute many additional benefits to our composition that were specifically covered above. Within our caramel flavored confection platform we add 1-glutamine as a supplement that helps promote weight loss. L-glutamine is a fatty acid oxidation inhibitor. Since fatty acid oxidation is linked to increased insulin output by the pancreas, glutamine supplementation prevents hyperinsulinemia, and enhances glucose utilization resulting in the reduction of hyperglycemia. In this manner, L-glutamin supplementation abolishes the characteristics insulin resistance associated with a high-fat diet. This adds a critical additional control on the peaks and valleys that occur within our current diet that are caused by spikes and declines in our glycemic levels. Because high fat diets can cause insulin output to increase 1-glutamine actually helps to enhance the utilization of glucose so the body can use the energy rather than being left still craving energy and being hungry. Below is a link to an article that talks about 1-glutamines affect on improving the processing of glucose.

www.vrp.com/articles.aspx?ProdID=609

It is another object of this invention to give the user a healthy chocolate or caramel flavored confection platform delivery system that uses controlled portion servings in a square or in a bar or a bar with pre-determined breaks within it. These portion controlled servings would be eaten throughout the day to give the user maximum control over food cravings, to improve the satiety of food eaten, and to promote the feeling of being full longer. The ability of our invention to give users a systematic way to promote 12 hour hunger control is a critical aspect of our invention's novel design. We suggest that users eat 1 square 30 minutes before each meal or right before eating each meal, 1 to 2 squares as a snack during the late night after dinner time period, and to eat “rescue squares” in situations where overeating may occur or strong food cravings may derail the user's healthy diet and weight loss program. The ability to control the user's diet in this manner gives the consumer ultimate control over food cravings, the ability to improve satiety and satisfaction of the food they eat, and promote the feeling of fullness throughout the day that together can generate a healthy weight maintenance and weight loss program.

In certain embodiments of this invention other foods and beverages including yogurt, ice cream, milk, fruit based beverages, energy drinks, nutritional beverages, cottage cheese, pudding, jello, apple sauce, cereal, confectionery products beyond chocolate and caramel, baked goods including; cookies, nutrition based baked snacks, muffins, bread, donuts, pies, cakes, or other foods that would be suitable for such a nutritive group of ingredients based on the composition that includes a high protein component at 10% (milk protein isolate), fiber component at 10% (blend of Inulin and fruit skins), edible oil component at 4% (blend of canola, soybean, sunflower), coconut oil component at 1.5% (90% virgin coconut and 10% refined medium heat), and an antioxidant component at 3% (ascorbic acid, tocopherols, anthocyanins). This group of foods and beverages would have this composition as the active ingredients to promote control over food cravings, to improve the satiety of food eaten, and to promote the feeling of being full longer. These food and beverages can be expanded into a complete food and beverage system that could be utilized along with the chocolate and caramel flavored delivery platforms to provide users a complete healthy diet to help sustain a healthy weight and or support a healthy weight loss program.

These and other objects and advantages of the present invention shall become apparent from the description.

In one embodiment of the invention a chocolate confection more specifically a dark chocolate confection has a complete group of nutritive ingredients within its composition that provides users with an ability to control food cravings, increase satiety or satisfaction from eating the composition, increases the feeling of fullness. A structured way to eat the healthy chocolate confection throughout the day is also provided within the invention.

Such a chocolate flavored confection composition comprises:
a. chocolate confection component at 45% (56% Cocoa Dark Chocolate)
b. high protein component-whey protein crisps at 15% (60% Protein)
c. fiber component at 15% (50% Psyllium Husk Powder and 50% Inulin)
d. edible oil component at 10% (blend of canola, soybean oil, and sunflower oil)
e. coconut oil component at 3% (100% virgin coconut oil)
f. antioxidant component at 10% (8% 100% Cocoa Powder and 2% blackberry powder)
g. supplement component at 5% (Chia Seeds)
h. 0.001% a natural preservative component (tocopherols)
i. 2% a vanilla powder component

An embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. edible oil component at 10% (blend of canola, soybean oil and sunflower oil), by weight of said composition.

A further embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition.

A further embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition; f. an antioxidant component at 10% (8% 100% Cocoa Powder and 2% blackberry powder), by weight of said composition.

A further embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition; f. an antioxidant component at 10% (8% 100% Cocoa Powder and 2% blackberry powder), by weight of said composition; g. an supplement component at 5% (Chia Seeds), by weight of said composition.

A further embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition; f. an antioxidant component at 10% (8% 100% Cocoa Powder and 2% blackberry powder), by weight of said composition; g. an supplement component at 5% (Chia Seeds), by weight of said composition; h. a 0.001% a natural preservative component (tocopherols).

A further embodiment of the present invention is a chocolate confection composition comprising: a. chocolate confection component at 45% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition; f. an antioxidant component at 10% (8% 100% Cocoa Powder and 2% blackberry powder), by weight of said composition; g.

an supplement component at 5% (Chia Seeds), by weight of said composition; h. a 0.001% a natural preservative component (tocopherols); and i. and a 2% a vanilla powder component.

Additionally, an embodiment of the present invention is a composition comprising the steps of: melting and tempering a dark chocolate component in a confectionery device that can also act as a mixer or the dark chocolate component would be put into a mixing vessel, then add the high protein (whey protein crisps), then add the fiber component, then add the liquid edible oil, coconut oil component, antioxidant component (100% Cocoa Powder and blackberry powder), then add the supplement component (Chia seeds), then add the natural antioxidant preservative (tocopherols) and finally add the antioxidant flavor component vanilla powder. The ingredients would be blended together for sufficient time to create a homogenous mixture

In a second embodiment of the present invention a caramel flavored confection composition has a complete group of nutritive ingredients within its composition that provides users with an ability to control food cravings, increase satiety or satisfaction from eating the composition, increases the feeling of being full. A structured way to eat the healthy chocolate confection throughout the day is also provided within the invention.

Such a composition comprises:
a. caramel flavored confection component at 50% (liquid edible oil component, coconut oil component, condensed skim milk component, monosaccharide component, disaccharide component, vanilla powder component, emulsifier component, and water component)
b. high protein component at 20% (milk protein isolate)
c. Inulin fiber component at 20%
d. antioxidant component at 5% (100% Cocoa Powder)
e. supplement component at 5% (I-glutamine)
f. 0.001% a natural preservative component (tocopherols)

An embodiment of the present invention is a composition comprising: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 20% (milk protein isolate), by weight of said composition; c. an Inulin fiber component at 20%, by weight of said composition; d. an antioxidant component (100% Cocoa Powder) at 5%, by weight of said composition; e. a supplement component at 5% (I-gutamine), by weight of said composition; a flavor component, a color component, a preservative component, a stabilizing component, a thickening component, or at least about 0% wt. % or greater of a supplement selected from the group consisting of: vitamins, minerals, herbs, botanicals, plant derived supplements, animal derived supplements, therapeutic compounds, and mixtures thereof; by weight of said composition.

A further embodiment of the present invention is a composition comprising: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 20% (milk protein isolate), by weight of said composition; c. an Inulin fiber component at 20%, by weight of said composition; d. an antioxidant component (100% Cocoa Powder) at 5%, by weight of said composition.

A further embodiment of the present invention is a composition comprising: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 20% (milk protein isolate), by weight of said composition; c. an Inulin fiber component at 20%, by weight of said composition; d. an antioxidant component (100% Cocoa Powder) at 5%, by weight of said composition; e. a supplement component at 5% (I-glutamine),by weight of said composition.

A further embodiment of the present invention is a composition comprising: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 20% (milk protein isolate), by weight of said composition; c. an Inulin fiber component at 20%, by weight of said composition; d. an antioxidant component (100% Cocoa Powder) at 5%, by weight of said composition; e. and a supplement component at 5% (I-gutamine), by weight of said composition.

A further embodiment of the present invention is a composition comprising: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 20% (milk protein isolate), by weight of said composition; c. an Inulin fiber component at 20%, by weight of said composition; d. an antioxidant component (100% Cocoa Powder) at 5%, by weight of said composition; e. a supplement component at 5% (I-gutamine), by weight of said composition; and a flavor component, a color component, a preservative component, a stabilizing component, a thickening component, or at least about 0% wt. % or greater of a supplement selected from the group consisting of: vitamins, minerals, herbs, botanicals, plant derived supplements, animal derived supplements, therapeutic compounds, and mixtures thereof; by weight of said composition.

Additionally, an embodiment of the present invention is a caramel flavored composition comprising the steps of mixing the corn syrup, sucrose, condensed skim, liquid edible oil, coconut oil, vanilla powder, and emulsifier, and water together and heat to 160 degrees Fahrenheit for 10 minutes to dissolve the sugar and emulsify the fats into a uniform mixture. Then increase the heat to 225 degrees Fahrenheit and slowly boil the ingredients for 15 minutes to produce the caramelization flavor and unique antioxidant flavor profile of our invention. The caramel flavored confection would then be reduced down to around 93 degrees Fahrenheit and the additional ingredients of the high protein source (milk protein isolate), the Inulin fiber, the antioxidant (100% Cocoa Powder), the supplement (I-glutamine), and a tocopherol or natural antioxidant preservative would be added to the composition. The composition would then be either sheeted and cut, extruded, or mold manufactured into portion control bite size pieces. If a hard caramel flavored confection is the desired finish product then the group of ingredients would be brought up in temperature to a very slow boil and reduced to the correct viscosity to produce the final product. This composition would then be extruded or mold manufactured into portion control bite size pieces. The final caramel flavored confections can then be packaged in any manner suitable for caramel flavored confections known in the industry.

In a third embodiment of the present invention a that provides a complete nutritional profile of ingredients that together has a synergistic effect in foods or beverages that provides control over food cravings, increases the satiety or satisfaction that the users gets from eating foods or beverages with this nutritive composition added to them, and when added to foods or beverages gives consumers the feeling of being full longer. A structured way to eat these foods and beverages that includes the composition provides users with a way to maintain a healthy weight and lose weight if that is their goal would be included.

Such a composition comprises:
a. high protein component at 10% (milk protein isolate)
b. fiber component at 10% (blend of Inulin and fruit skins)
c. edible oil component at 4% (blend of canola, soybean, sunflower)
d. coconut oil component at 1.5% (90% virgin coconut and 10% refined medium heat)
e. antioxidant component at 1% (ascorbic acid, tocopherols, anthocyanins)
f. a supplement at 0% or greater

An embodiment of the present invention is a composition comprising: a. high protein component at 10% (milk protein isolate), by weight of said composition; b. and a fiber component at 10% (blend of Inulin and fruit skins), by weight of said composition.

A further embodiment of the present invention is a composition comprising: a. high protein component at 10% (milk protein isolate), by weight of said composition; b. a fiber component at 10% (blend of Inulin and fruit skins) by weight of said composition; c. and edible oil component at 4% (blend of canola, soybean, and sunflower), by weight of said composition.

A further embodiment of the present invention is a composition comprising: a. high protein component at 10% (milk protein isolate), by weight of said composition; b. a fiber component at 10% (blend of Inulin and fruit skins), by weight of said composition; c. an edible oil component at 4% (blend of canola, soybean, and sunflower), by weight of said composition; d. and a coconut oil component at 1.5% (90% virgin coconut and 10% refined medium heat coconut, by weight of said composition.

A further embodiment of the present invention is a composition comprising: a. high protein component at 10% (milk protein isolate), by weight of said composition; b. a fiber component at 10% (blend of Inulin and fruit skins), by weight of said composition; c. an edible oil component at 4% (blend of canola, soybean, and sunflower), by weight of said composition; d. and a coconut oil component at 1.5% (90% virgin coconut and 10% refined medium heat coconut, by weight of said composition; e. and a antioxidant component at 1% (ascorbic acid, tocopherols, and anthocyanins).

A further embodiment of the present invention is a composition comprising: a. high protein component at 10% (milk protein isolate), by weight of said composition; b. a fiber component at 10% (blend of Inulin and fruit skins), by weight of said composition; c. an edible oil component at 4% (blend of canola, soybean, and sunflower), by weight of said composition; d. and a coconut oil component at 1.5% (90% virgin coconut and 10% refined medium heat coconut, by weight of said composition; e. and a antioxidant component at 1% (ascorbic acid, tocopherols, and anthocyanins); f. a supplement component at 0% or greater, by weight of said composition.

Additionally, an embodiment of the present invention comprises adding the above group of ingredients that provide a synergistic effect in foods or beverages helping users control food cravings, increase the satiety or satisfaction that the users get from eating foods or beverages with this nutritive composition added to them, and when added to foods or beverages gives users the feeling of being full longer. This group of ingredients that make up this composition can be added to the following group of foods and beverages and is not limited by any way to the following group of foods and beverages including; yogurt, ice cream, milk, fruit based beverages, energy drinks, nutritional beverages, dairy products, cottage cheese, cream cheese, pudding, jello, apple sauce, cereal, confectionery products beyond chocolate and caramel, baked goods including; cookies, nutrition based baked snacks, muffins, bread, donuts, pies, cakes, cookies and other foods that would be suitable for such a nutritive group of ingredients to be added to them.

### DETAILED DESCRIPTION

### Definitions

All percentages and ratios are calculated by weight unless otherwise indicated. All percentages and ratios are calculated based on the total final composition unless otherwise indicated.

Referenced herein may be trade names for components including various ingredients utilized in the present invention. The inventors herein do not intend to be limited by materials under a given trade name. Equivalent materials (e.g., those obtained from a different source under a different name or reference number) to those referenced by trade name may be substituted and utilized in the description.

As used herein “fiber” generally means material derived from plant cell walls and which is not digestible by human digestive enzymes, including soluble fiber and insoluble fiber. The fiber component can be naturally derived or synthetic. A portion of the fiber component can be non-starch polysaccharides, including soluble and non soluble fiber. As used herein “soluble fiber” means plant gums and oligosaccharides, or modified gums, modified celluloses, non-starch polysaccharides that are soluble in water, some of which can form viscous gels.

### The Invention

Generally, as known in prior art many patents have been granted for compositions or compounds that have certain health benefits that target weight loss, appetite control, satiety, and food cravings. Our current invention focuses on all of the above weight loss and weight maintenance issues that consumers face in order to be successful in maintaining a healthy weight and losing weight and specifically keeping the weight off long-term. Through years of research and development we broke down all the issues and aspects that consumers face when trying to maintain a healthy diet and losing weight. We found out that it is critical to target all these physical and mental aspects in total that the human body must overcome in order to eat the right amount of food for a healthy diet and being able to control their appetite and food choices on a long-term basis. Many individuals have lost weight and gained it back over and over. An article below shows that 95% of individuals gain their weight back that they lose dieting. Our invention takes a systematic approach to a healthy weight management and diet program and gives users a long-term plan to help them change their eating habits through a routine regimen of eating portion control healthy chocolate and caramel flavored confections and other foods and beverages made with the addition of our nutritional composition discussed above in our third embodiment of our invention.

www.springerlink.com/content/p63t762005761391/

Our invention targets the relevant aspects of a healthy weight maintenance program and a way to diet and lose weight and keep the weight off.

The relevant aspects of our invention that help users maintain a healthy weight and support losing weight and keeping the weight off are the following:
Control food cravings by having portion control squares throughout the day. This provides the user with a level glycemic response throughout the day and normal blood sugar levels are scientifically proven to reduce food cravings.
Increase satiety and satisfaction of the food eaten by having a portion control square 30 minutes or as close as possible prior to each meal. Science has proven that certain nutritive ingredients improve the satiety of food eaten. Protein, fiber, a balance group of edible oils, antioxidants, and supplements within the present invention all contribute to improved satiety.
Provide the feeling of being full and content after eating by giving users nutritional based portion control squares that promote the feeling of fullness that include; protein, fiber, and a balance of edible oils that give immediate energy as well as long-term steady release of energy. Science has proven that this group of nutritive ingredients supports feeling full longer and content after eating foods containing these ingredients.
Provide a regimen for eating portion control squares or bars as a daily program whereas one square is eaten before each meal and one to two squares are eaten as after dinner or evening snacks or a bar that equals three squares is used as a meal replacement and one square would be eaten before the other two meals during the day. This 5 Squares A Day is a core principle within the present invention that provides nutrition necessary to maintain a healthy weight maintenance and weight loss program.
Provide a “rescue square” concept that gives users a timely way to prevent overeating or eating foods that shouldn't be one's healthy diet lifestyle. The ability to use a portion control square at any point throughout the day allows users flexible control over preventing the chance of making a poor food decision or overeating. This “rescue square” concept is critical when users are put in situations like going out to eat, going to a party where lots of food is available or any other situation that the user may encounter. Rescue squares should also be used before doing major grocery shopping in order to bring blood sugar levels into a better balance; thus, making it easier to make better food purchase choices. Studies have shown that consumers make completely different purchase behavior based on whether they are hungry when shopping or content.
The present invention will incorporate our nutritional into a wide variety of foods and beverages that can give users targeted health benefits necessary to control food cravings, increase satiety and satisfaction, and promote feeling fullness. These foods and beverages can include; yogurt, ice cream, milk, fruit based beverages, energy drinks, nutritional beverages, dairy products, cottage cheese, cream cheese, pudding, jello, apple sauce, cereal, confectionery products beyond chocolate and caramel, baked goods including; cookies, nutrition based baked snacks, muffins, bread, donuts, pies, cakes, cookies and other foods that would be suitable for such a nutritive group of ingredients to be added to them.

Three embodiments of the current invention include a healthy nutritive based chocolate technology, a nutritive based caramel flavored confection technology, and a nutritive composition group of ingredients that can be added to foods and beverages. These embodiments of the present invention are the following;
1) Through experimentation and extensive research and development it was discovered that an embodiment of the present invention comprises a dark chocolate composition more specific having: a. chocolate confection component at 43% (56% Cocoa Dark Chocolate), by weight of said composition; b. a high protein component (whey protein crisps at 15% (60% protein content), by weight of said composition; c. a fiber component at 15% (50% psyllium-½ whole husks and ½ psyllium husk powder) and 50% Inulin, by weight of said composition; d. an edible oil component at 10% (blend of canola, soybean oil and sunflower oil), by weight of said composition; e. a coconut oil component at 3% (100% virgin coconut oil), by weight of said composition; f. an antioxidant component at 8% (6% 100% Cocoa Powder and 2% blackberry powder), by weight of said composition; g. a supplement component at 4% (Chia Seeds), by weight of said composition; h. add a 0.001% a natural preservative component (tocopherols) to the final weight of the composition; and i. and a 2% a vanilla powder component.
2) Through experimentation and extensive research and development it was discovered that an embodiment of the present invention comprises a caramel flavored confection composition more specific having: a. a caramel confection component at 50% of the composition that consists of the following (monosaccharide corn syrup at 18%, disaccharide sucrose at 18%, condensed skim milk at 20%, a liquid edible oil component at 12% (blend of canola, soybean oil and sunflower oil, a 3% coconut oil component (0% to 16% virgin coconut oil and 84% to 100% refined coconut oil, and a vanilla powder component at 3%, a fiber component at 7%, a water component at 8.5%, and an emulsifier component 0.5%, by weight of said composition; b. a high protein component at 18% (milk protein isolate), by weight of said composition; c. an Inulin fiber component at 18%, by weight of said composition; d. an antioxidant component (100% Cocoa Powder) at 5%, by weight of said composition; e. a supplement component at 9% (I-gutamine), by weight of said composition; f. a natural preservative component of tocopherols at 0.001% of the final weight of the composition, and a flavor component, a color component, a preservative component, a stabilizing component, a thickening component, or at least about 0% wt. % or greater of a supplement selected from the group consisting of: vitamins, minerals, herbs, botanicals, plant derived supplements, animal derived supplements, therapeutic compounds, and mixtures thereof; by weight of said composition.
3) Through experimentation and extensive research and development it was discovered that an embodiment of the present invention comprises a nutritional composition more specific having: a. high protein component at 10% (milk protein isolate), by weight of said composition; b. a fiber component at 10% (blend of

Inulin and fruit skins), by weight of said composition; c. an edible oil component at 5% (blend of canola, soybean, and sunflower), by weight of said composition; d. and a coconut oil component at 2% (90% virgin coconut and 10% refined medium heat coconut, by weight of said composition; e. and a antioxidant component at 2% (ascorbic acid, tocopherols, and anthocyanins); f. a supplement component at 0% or greater, by weight of said composition.

### Chocolate Component

In the first embodiment of the present invention a chocolate component makes up at least 30% or greater, alternatively 30% to 35%, alternatively 35% to 40%, alternatively 40% to 45%, alternatively 45% to 50%, alternatively 50% to 55%, alternatively 55% to 60%, alternatively 60% to 65%, alternatively 65% to 70%, alternatively 70% to 80%, alternatively 80% to 85%, alternatively 85% to 90%, alternatively 90% to 95%, alternatively 95% to 99%, by weight of said composition. Within this invention our preferred chocolate component chosen is dark chocolate at a 56% Cocoa percentage. Other chocolate sources could be chosen including; milk chocolate, sweet chocolate, bittersweet chocolate, and white chocolate. We chose a dark chocolate with a 56% Cocoa percentage because of its health characteristics and because it has a low glycemic index which means it releases its energy into the body over a longer period of time, has high antioxidant content, and good chocolate flavor profile. High Cocoa dark chocolate is also high in fiber which supports slowing down the digestion of carbohydrates and gives sustained energy over a longer period of time and this promotes satiety and the feeling of being full. Antioxidants are also extremely important in preventing damage from free radicals that are caused from exercise and especially during the process of losing weight. High Cocoa dark chocolate has potent antioxidants that can help combat the free radicals that are created during the weight loss process and during exercise and can actually help the user stay on their diet and weight loss or healthy weight maintenance program. The 56% Cocoa percentage dark chocolate would be all natural and not processed with alkali that destroys 40% to 90% of dark chocolate's beneficial antioxidants.

Caramel Flavored Confection Component

In the second embodiment of the present invention a caramel flavored confection makes up at least 30% or greater, alternatively 30% to 35%, alternatively 35% to 40%, alternatively 40% to 45%, alternatively 45% to 50%, alternatively 50% to 55%, alternatively 55% to 60%, alternatively 60% to 65%, alternatively 65% to 70%, alternatively 70% to 80%, alternatively 80% to 85%, alternatively 85% to 90%, alternatively 90% to 95%, alternatively 95% to 99%, by weight of said composition. Within this invention our preferred caramel flavored confection would be made from the finest all natural ingredients including; corn syrup, sucrose, condensed skim milk, an edible oil blend, a coconut oil component, a fiber component, a vanilla powder component, an emulsifier component, a water component and a natural preservative component. We could use another caramel flavored confection as the base ingredient for our invention, but we have a specific group of ingredients that make a unique tasting healthier caramel flavored confection that has health characteristics that contribute a healthy weight maintenance and weight loss system. Our caramel flavored confection has a beneficial balance of fats that provide energy immediately from medium chain triglycerides found in coconut oil and some of the unsaturated fats within the edible oil blend release energy slowly over a longer time period. The immediate release of energy helps prevent food cravings by giving the user immediate access to energy and the fats that release energy over a longer period of time help prevent future cravings. It also helps to improve satiety because the user gets an immediate satisfaction from the energy released from the medium chain triglycerides.

### High Protein Component

In the first and second embodiments of the present invention a high protein component at 0.001% to 30%, alternatively 0.001% to 5%, alternatively 5% to 10%, alternatively 10% to 15%, alternatively 15% to 20%, alternatively 20% to 25%, alternatively 25% to 30%, by weight of said composition. In the third embodiment of the present invention a high protein component at 8% to 10%, by weight of said composition. Several protein sources are used based on the technology platform being chosen and whey protein crisps and milk protein isolate are the preferred protein sources. Protein is an essential part of a healthy weight management and weight loss program. Protein actually helps to improve satiety or satisfaction in foods that contain it. Protein is digested slowly compared to carbohydrates and actually can be a good way to prevent food cravings by giving users a continued level amount of energy to keep from having the sugar highs and lows that cause individuals to crave certain foods. Protein also helps you feel full longer. Because protein has a complex structure and the body takes longer to process it into energy individuals feel fuller longer when eating foods that include good levels of protein.

### High Fiber Component

In the first and second embodiments of the present invention a high fiber component at 0.001% to 30%, alternatively 0.001% to 5%, alternatively 5% to 10%, alternatively 10% to 15%, alternatively 15% to 20%, alternatively 20% to 25%, alternatively 25% to 30%, by weight of said composition. In the third embodiment of the present invention a high protein component at 8% to 10%, by weight of said composition. Several types of fiber are used within our invention and we include both bulk forming fiber and non-bulk forming fiber. Psyllium and fruit skins are a preferred form of bulk forming fiber and

Inulin is the preferred form of non-bulk forming fiber within our invention. Fiber plays a special role within a healthy weight maintenance and weight loss program. Fiber has many benefits that contribute to weight management including having a benefit of balancing blood sugar that can help control food cravings by leveling the peaks and valleys in blood sugar that is proven to cause food cravings. Fiber also has an effect on satiety because it makes you feel full especially fiber sources like psyllium that has hydrophilic characteristics and can swell to 12 times its regular size when added to water. This aspect allows psyllium to take up space in the digestion system and when taken with liquid actually turns viscous in the digestion system and makes you feel full and improves satiety of foods. Fiber is one of the core aspects of this invention that has a wide group of benefits for helping a user maintain a healthy weight and lose weight.

### Edible Oil Component

In embodiments of our invention there is an edible oil component at 0.001% to 30%, alternatively 0.001% to 5%, alternatively 5% to 10%, alternatively 10% to 15%, alternatively 15% to 20%, alternatively 20% to 25%, alternatively 25% to 30%, alternatively 30% to 35%, alternatively 35% to 40%, by weight of said composition. This edible oil component adds beneficial fats to the technology platforms including monounsaturated and polyunsaturated oils. In certain embodiments of the invention essential fatty acids Omega 6 and Omega 3 are added into the compositions. The preferred group of edible oils used in the invention is a blend of canola oil, soybean oil, and sunflower oil. Other oils that have high levels of unsaturated fats including; safflower oil, sesame oil, walnut oil, olive oil, flaxseed oil, chia seed oil, almond oil, corn oil, grape seed oil, peanut oil, other nut oils, and combinations thereof or other edible oils or synthesized or rearranged oils with similar characteristics that have a high level of unsaturated fatty acids. Unsaturated fats like the ones found in the blend of canola oil, soybean oil, and sunflower oil are processed slowly into energy in the human body. The oils have a small part of them less than 10% that are saturated fats that release energy quicker, but the majority of the energy contained in the edible oils release energy over a long period of time. This immediate release of energy can help promote satiety. The majority of the energy that is released slowly increases the length of satiety or satisfaction of the food eaten and especially can make users feel fuller longer.

### Coconut Oil Component

In all three of our embodiments of our invention there is a coconut oil component at 0.001% to 15%, alternatively 0.001% to 5%, alternatively 5% to 10%, alternatively 10% to 15%, by weight of said composition. In the healthy nutritionally based chocolate platform technology the coconut oil contained within the composition is virgin coconut oil. In the healthy nutritionally based caramel flavored confection technology the coconut oil contained is refined medium heat coconut oil and in the nutritional based composition that can be added to a wide range of foods and beverages the coconut oil component can come from either virgin coconut or from medium heat refined coconut depending on the type of food or beverage and the flavor profile desired. Coconut oil has multiple aspects of its health characteristics that support a healthy weight maintenance and weight loss program. Coconut oil is a very powerful antioxidant and as discussed above antioxidants work to protect the body against free radicals. Free radicals are creating during the process of exercising that is important in any weight maintenance and weight loss program. When the body loses fat it creates toxins that can attack the body and make the dieter feel sluggish, weak and have loss of energy.

Antioxidants like coconut oil help to combat these free radicals let go in the body during periods of dieting and weight loss. Coconut is also high in medium chain triglycerides that the body converts to immediate energy. Coconut can work to improve the satiety or satisfaction when you eat a food containing the edible oil. Coconut also is made up of other saturated fats that give the body necessary longer term energy that can help promote the feeling of being full.

### Antioxidant Component

Antioxidants are part of all three of the embodiments within this invention including the healthy based chocolate technology, the healthy caramel flavored confection technology and the group of nutritional ingredients that make up the composition that can be added to foods and beverages. The three embodiments of the invention have an antioxidant component at 0.001% to 5%, alternatively, 5% to 10%, alternatively 10% to 15%, alternatively 15% to 20%. The primary antioxidants within this invention are 100% Cocoa Powder, Blackberry Powder, ascorbic acid, tocopherols, and anthocyanins plus many of the other ingredients within embodiments of this invention also have antioxidant characteristics including dark chocolate, edible oils, coconut oil, and vanilla powder. Antioxidants are one of the nutrients that dieticians and nutritionists alike are starting to recommend as a necessary part of a healthy weight maintenance and weight loss system. Physicians recommend as well as does the USDA and American Heart

Association that exercise is critical for long-term successful weight maintenance and weight loss success. Studies now show that exercise can actually improve the metabolism within the body and can continue burning calories long after the exercise is ended. The body needs antioxidants to combat the oxidation process that goes on within the cellular level of the body during exercise. Antioxidants are proven to help combat these free radicals caused by exercise and aid in the body's ability to stay healthy. Antioxidants also help fight toxins released in the body as fat is destroyed. The process of the fat cells being destroyed is oxidation and many antioxidants can help combat this process.

### Supplement Component

Supplements can be part of all three embodiments of this invention at 0% or greater, by weight of said composition. Supplements provide many different health benefits especially ones that contribute to a healthy weight maintenance and weight loss system. Chia seeds are the preferred supplement in the first embodiment of this invention that is the healthy chocolate based technology. Chia seeds are edible small seeds that have one of the most balanced nutritional profiles of any plant material in the world. Chia seeds are made up of 35% edible oils with a high concentration of Omega 3 ALA's or alpha linolenic, Omega 6 or linoleic, and saturated fat, 25% of the seed is made of fiber with a balance of soluble and insoluble fiber, 20% protein, abundant amino acids, and a group of antioxidants unique to the Chia seed plus beneficial nutrients and vitamins.

Chia seeds are almost a perfect food and contribute many health benefits to our chocolate technology including benefits from edible oils, fiber, protein, and antioxidants. These health benefits support control of food cravings, increase satiety, and promote the feeling of being full longer all from one little seed.

L-glutamine is the preferred supplement in the second embodiment of this invention that is the health driven caramel flavored confection. L-glutamine has many health benefits that support healthy weight maintenance and weight loss including; 1) balancing blood sugar levels that can help users control food cravings, 2) protects the body from stress which can help when fat is being destroyed during weight loss and toxins in the body cause malice, sluggishness, and lack of energy, and 3) increase energy levels that promotes the feeling of satiety or satisfaction in what you eat.

Supplements can be added to the third embodiment of this invention. Currently we only have a list of potential supplement categories that could be added that includes;

vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, resveratol, catechins and polyphenols from teas, onions, phytosterols, isoflavones, lycopene, curcumin, caffeine; glucosamine, chondroitin, msm; melatonin, seratonin; and mixtures thereof.

### Additional Components

Additional component or components would be added selected from the group consisting of; a flavor component, a sweetener component, a color component, a preservative component, a stabilizing component, an emulsifier component, a thickening component, a filling component, a layering component, a nut component, a fruit piece component, etc. or combinations thereof to create additional flavors and varieties.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0% to 2%, by weight of the composition a preservative component from above or mixtures thereof.

### Method of Making

### EXAMPLES

The below examples are included for illustrative purposes only and are not intended to in any way limit the scope of the present invention.

### Example 1

A dark chocolate based confection square with a complete group of nutritive ingredients that help users control food cravings, increase satiety or satisfaction is what they eat, and help users feel full longer

Add 45# of 56% Cocoa dark chocolate to a device that can melt and temper the chocolate and also act as a mixer or take the melted and tempered dark chocolate and put it in a mixer that can keep the deat at around 90 degrees Fahrenheit, add 15# of whey protein crisps (60% Protein) supplied by Kerry Dairy Ingredients, add 15# of fiber (50% Psyllium husk powder and 50% Inulin), then add 10# of edible oil blend (blend of canola, soybean oil, and sunflower oil), then add 3# of virgin coconut oil, then add 10# of an antioxidant blend (8# of 100% Cocoa Powder and 2# of Blackberry Powder), then add 5# of Chia seeds , then add 2# of vanilla powder, then add 0.001% of a natural preservative to the composition and mix all the ingredients together in a large mixing devise for around 10 minutes or until homogeneous. D then be put into 15 gram chocolate square molds then they would be refrigerated for 40 minute to allow the chocolate to properly set. The pieces would then be flow wrapped and packaged in any format used within the confectionery packaging industry including cartons, bags, boxes, etc. This formula can easily be scaled up to create large volume of the composition.

### Example 2

A caramel flavored confection chew with a complete group of nutritive ingredients that help users control food cravings, increase satiety or satisfaction is what they eat, and help users feel full longer

Add 50# of caramel flavored confection component that includes a liquid edible oil component, coconut oil component, condensed skim milk component, monosaccharide component, disaccharide component, vanilla powder component, emulsifier component, and water component. This would be made by adding the above ingredients in specified percentages and heating it two 160 degrees for 5 minutes to dissolve the sugar and emulsify the edible oils. Then increase the heat to 225 degrees Fahrenheit and bring to a slow rolling boil for 15 minutes or longer depending on the thickness desired for the final caramel flavored component, then cool the caramel flavored component down to around 93 degrees and add 20# of a protein component (milk isolate), then add 20# of Inulin fiber, then add 5# of 100% Cocoa Powder, then add 5# of I-glutamine powder, and finally add 0.001% tocopherols a natural preservative component and mix the ingredients until completely homogeneous. The caramel flavored confection would then either be sheeted and cut, extruded, or made with confectionery molds. The pieces would then be flow wrapped and packaged in any format used within the confectionery packaging industry including cartons, bags, boxes, etc. This formula can easily be scaled up to create large volume of the composition.

### Example 3

A complete nutrition group of ingredients as part of a skim milk that helps users control food cravings, increase satiety or satisfaction in what they eat, and help users feel full longer

Add 10# of skim milk into a mixing devise suitable for making dairy type compositions and that can also act as a mixer, add 1# of high protein component (milk protein isolate), add 1# of fiber component (blend of Inulin and colorless fruit skins), add 4# of an edible oil blend consisting of canola oil, soybean oil and sunflower oil, add 1.5# of coconut (90% virgin coconut and 10% refined medium heat coconut), add 1# of an antioxidant blend component (ascorbic acid, tocopherols, and anthocyanins) and blend for sufficient time to create a homogenous mixture. Then the milk would be packaged in any format suitable for milk. This process can easily be increased in operation to large scale commercial production.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composition that provides a source of balanced nutrition and controls food cravings, increases satiety, promotes a feeling of fullness, consists of the following; a. 30% or greater a chocolate or caramel flavored confection or combination of both, by weight of said composition; b. a high protein component at 0.001% to 30%, by weight of said composition; c. a fiber blend component at 0.001% to 30%, by weight of said composition; d. an edible oil component with high levels of unsaturated fats at 0.001% to 40%, by weight of said composition; e. a virgin coconut oil or coconut oil at 0.001% to 15%, by weight of said composition; f. an antioxidant component that comes from natural sources at 0.001% to 20%, by weight of said composition; g. a supplement component at 0% or greater, by weight of said composition

2. A composition that can be added to foods or beverages that provides a balance group of nutritive ingredients that can control food cravings, increase satiety, promote the feeling of being full consists of; a. a high protein component at 0.001% to 30%, by weight of said composition; b. a fiber blend component at 0.001% to 30%, by weight of said composition; c. an edible oil component with high levels of unsaturated fats at 0.001% to 40%, by weight of said composition; d. a virgin coconut or coconut oil at 0.001% to 15%, by weight of said composition; e. an antioxidant component that comes from natural sources at 0.001% to 20%, by weight of said composition; f. a supplement component at 0% or greater, by weight of said composition.

3. The composition of claim 2 wherein said composition is in the form of a powder, wherein said composition is part of a liquid drink, wherein said composition is part of a nutrition/snack type bar, wherein said composition is taken before a meal, wherein said composition is taken during the consumption of a meal, wherein said composition is a food additive within other foods.

4. The composition of claim 2 wherein said composition is a food additive that is part of the group of foods including; yogurt, ice cream, milk, fruit based beverages, energy drinks, nutritional beverages, cottage cheese, pudding, jello, apple sauce, cereal, confectionery products beyond chocolate and caramel, baked goods including; cookies, nutrition based baked snacks, muffins, bread, donuts, pies, cakes, or other foods that would be suitable for such a nutritive group of ingredients.

5. The composition of claim 1 wherein a chocolate or caramel flavored confection is 30% or greater, alternatively 30% to 35%, alternatively 35% to 40%, alternatively 40% to 45%, alternatively 45% to 50%, alternatively 50% to 55%, alternatively 55% to 60%, alternatively 60% to 65%, alternatively 65% to 70%, alternatively 70% to 80%, alternatively 80% to 85%, alternatively 85% to 90%, alternatively 90% to 95%, alternatively 95% to 99%, by weight of said composition.

6. The composition of claim 5 wherein a chocolate or caramel flavored confection component is chocolate and comes from a dark chocolate that has a cocoa percentage of 56% or greater and that is all natural with no milk fat, artificial flavors and that isn't processed with alkali.

7. The composition of claim 5 wherein the chocolate or caramel flavored confection component is a caramel flavored confection that is made with the following ingredients; a liquid edible oil component, a coconut oil component, a milk solids component, a monosaccharide component, disaccharide component, a vanilla powder component, an emulsifier component, and a water component and a natural preservative tocopherol component. This caramel flavored confection would have the right viscosity and water content to allow easy incorporation of the additional composition ingredients.

8. The composition of claim 1 and claim 2 wherein a high protein component is 0.001% to 30%, alternatively 0.001% to 5%, alternatively 5% to 10%, alternatively 10% to 15%, alternatively 15% to 20%, alternatively 20% to 25%, alternatively 25% to 30%, by weight of said composition.

9. The composition of claim 8 wherein a high protein component is comprised of the group of protein sources including; whey isolate, milk protein isolates, soy protein, whey protein crisps, soy protein crisps, milk protein crisps, chia seeds powder, calcium caseinate, lactose dairy protein, or other suitable sources of protein stable in food platforms.

10. The composition of claim 1 wherein a whey protein crisp or milk protein crisp is the preferred high protein component within said invention when a chocolate confection component is used and wherein when the composition made is within claim 2 or when a caramel flavored confection is chosen in claim 1 milk protein isolate, lactose dairy protein or calcium caseinate are the preferred high protein component within said invention.

11. The composition of claim 1 and claim 2 wherein a fiber blend component is 0.001% to 30%, alternatively 0.001% to 5%, alternatively 5% to 10%, alternatively 10% to 15%, alternatively 15% to 20%, alternatively 20% to 25%, alternatively 25% to 30%, by weight of said composition.

12. The composition of claim 11 wherein a fiber blend component is comprised of the group of the fiber sources including; naturally derived soluble fiber, naturally derived inulin, inulin extract, synthetic inulin, hydrolysis products of inulin commonly known as fructooligosaccharides, galacto-oligosaccharides, xylooligosaccharides, oligo derivatives of starch; husks; brans; psyllium; polysaccharides, starches; polycarbophil; lignin; arabinogalactans; chitosans; oat fiber; soluble corn fiber, non-digestible corn dextrin; non-digestible wheat dextrin; locust bean gum and derivatives of locust bean gum; hydroxypropylmethyl cellulose (HPMC);pectin; and mixtures thereof.

13. The composition of claim 12 wherein the fiber component consists of naturally derived Inulin or psyllium or both are the preferred fiber source of this invention.

14. The composition of claim 1 and claim 2 wherein an edible oil component is 0.001% to 40%, alternatively 0.001% to 5%, alternatively 5% to 10%, alternatively 10% to 15%, alternatively 15% to 20%, alternatively 20% to 25%, alternatively 25% to 30%, alternatively 30% to 35%, alternatively 35% to 40%, by weight of said composition.

15. The composition of claim 14 wherein the edible oil component is comprised of the group of edible oils including; canola oil, soybean oil, safflower oil, sunflower oil, sesame oil, walnut oil, olive oil, flaxseed oil, chia seed oil, almond oil, corn oil, grape seed oil, peanut oil, other nut oils, and combinations thereof or other edible oils or synthesized or rearranged oils with similar characteristics that have a high level of unsaturated fatty acids.

16. The composition of claim 1 and claim 2 wherein a coconut oil component is 1% to 15%, alternatively 1% to 5%, alternatively 5% to 10%, alternatively 10% to 15%, by weight of said composition.

17. The composition of claim 16 wherein a coconut oil component is comprised of coconut oils including; virgin coconut oil, medium heat refined coconut oil, or coconut oil that has been refined using solvents.

18. The composition of claim 17 wherein a virgin coconut oil component is used within the chocolate confection platform compositions, (0% to 33% virgin coconut oil and 67% to 100% medium heat refined coconut oil) is used within the caramel flavored confection platform compositions and virgin coconut oil or medium heat refined coconut oil can be used in compositions within claim 2 above.

19. The composition of claim 1 and claim 2 wherein a naturally derived antioxidant component is 0.001% to 20%, alternatively 0.001% to 5%, alternatively 5% to 10%, alternatively 10% to 15%, alternatively 15% to 20%, by weight of said composition.

20. The composition of claim 19 wherein a naturally derived antioxidant component is comprised of the group of naturally derived antioxidant components including;
berry powders (blackberry, raspberry, black raspberry, marion blackberry, blueberry, strawberry, cranberry, Acai berry, goji berry, bilberry, passion fruit, cherry, pomegranate, or other suitable high antioxidant berry powders), 100% cocoa powder, resveratol, ascorbic acid, glutathione, melatonin, carotene, tocopherols, anthocyanins, procyandins, lycopene, flavanoids, flavanols, other naturally derived antioxidants and combinations thereof.

21. The composition of claim 20 wherein 100% cocoa powder and blackberry powder are the preferred naturally occurring antioxidant components added in the chocolate confection platform compositions and 100% cocoa powder is the preferred antioxidant component added in the caramel flavored confection platform composition and ascorbic acid, tocopherols, and anthocyanins are the preferred antioxidant component of claim 2.

22. The composition of claim 1 and claim 2 wherein at least 0% or greater a supplement component consisting of the following; vitamins, minerals, herbs, botanicals, essential fatty acids, seeds, plant derived supplements including sterols and stanols, animal derived supplements, therapeutic compounds, and mixtures thereof; by weight of said composition.

23. The composition of claim 1 and claim 2 wherein an additional component or components would be added selected from the group consisting of; a flavor component, a sweetener component, a color component, a preservative component, a stabilizing component, an emulsifier component, a thickening component, a filling component, a layering component, nuts, fruit pieces, etc. or combinations thereof to create additional flavors and varieties.

24. The composition of claim 1 wherein a chocolate confection more specifically would comprise the following:
a. chocolate confection component at 45% (56% Cocoa Dark Chocolate)
b. high protein component-whey protein crisps at 15% (60% Protein)
c. fiber component at 15% (50% Psyllium Husk Powder and 50% Inulin)
d. edible oil component at 10% (blend of canola, soybean oil, and sunflower oil)
e. coconut oil component at 3% (100% virgin coconut oil)
f. antioxidant component at 10% (8% 100% Cocoa Powder and 2% blackberry powder)
g. supplement component at 5% (Chia Seeds)
h. 0.001% a natural preservative component (tocopherols)
i. 2% a vanilla powder component

25. The composition of claim 1 wherein a caramel flavored confection more specifically would comprise the following:
a. caramel flavored confection component at 50% (liquid edible oil component, coconut oil component, condensed skim milk component, monosaccharide component, disaccharide component, vanilla powder component, emulsifier component, and water component)
b. high protein component at 20% (milk protein isolate)
c. Inulin fiber component at 20%
d. antioxidant component at 5% (100% Cocoa Powder)
e. supplement component at 5% (I-glutamine)
f. 0.001% a natural preservative component (tocopherols)

26. The composition of claim 2 wherein a nutritional composition would comprise the following:
a. high protein component at 8% to 10% (milk protein isolate)
b. fiber component at 8% to 10% (blend of Inulin and fruit skins)
c. edible oil component at 4% (blend of canola, soybean, sunflower)
d. coconut oil component at 1.5% (90% virgin coconut and 10% refined medium heat)
e. antioxidant component at 3% (ascorbic acid, tocopherols, anthocyanins)

27. The composition of claim 24 and claim 25 wherein said composition comprises a form selected from the group consisting of: bite size pieces, chews, portion control squares or bars, pre-determined breaks within bars to aid in portion control. The form of said composition is designed to support weight loss by utilizing portion controlled squares or bars eaten throughout the day to provide control over food cravings, increase satiety, and promote the feeling of fullness which supports weight loss and or sustaining a healthy weight.

28. The composition of claim 26 wherein said composition comprises a form selected from the group consisting of: yogurt, ice cream, milk, fruit based beverages, energy drinks, nutritional beverages, cottage cheese, pudding, jello, apple sauce, cereal, confectionery products beyond chocolate and caramel, baked goods including; cookies, nutrition based baked snacks, muffins, bread, donuts, pies, cakes, or other foods that would be suitable for such a nutritive group of ingredients.

29. The composition of claim 24, claim 25, and claim 26 wherein said composition is utilized in a complete diet and weight loss approach that provides the user 12 hours of appetite control and a way to systematically lose weight and or maintain a healthy weight. The diet and weight loss system consists of several key elements that contribute to healthy weight loss and/or weight maintenance. The system includes the following key aspects;
a. Each portion controlled square or bar or other food source that contains a complete nutritive group designed to provide control of food cravings, increase satiety, promote fullness, and promotion of a level glycemic response over an entire day when the recommended daily eating schedule is incorporated into a typical daily diet.
b. Eat one 12-15 gram portioned controlled square or section of a pre-divided bar 30 minutes before each meal with an eight ounce glass of water.
c. Eat one to two 12-15 gram portioned controlled squares or sections of a pre-divided bar as a snack after dinner to prevent late night eating.
d. Utilize one 12-15 gram portion controlled square or section of a pre-divided bar in time of crisis, which means at a point where user might eat something outside of their healthy diet.
e. Utilize 1.6 ounce complete nutrition meal replacement bars as an adjunctive part of a healthy diet and or as part of an appetite control program and then utilize portion controlled 12-15 gram squares during the rest of the day.
f. Other food or beverage platforms could be incorporated into the same eating system described above with a recommended controlled portion taken with eight ounces of water prior to a meal, late night snacks, or prior to “times of possible overeating crisis as described above including potentially different meal replacement offerings as covered under claim 26.

30. A method of preparing a composition of claim 24 that creates a chocolate based confection having a complete group of nutritive ingredients that when ingested synergistically affect users and give them control over food cravings, improve satiety, and promotes a feeling of fullness to support healthy weight loss and or weight maintenance, comprises of: a. melting and tempering the chocolate component in a device that can act as a mixer or add it into a mixer once melted and tempered; b. add the edible oil component; c. add the coconut oil component; d. add the 100% Cocoa powder antioxidant component; e. add the vanilla powder flavor component and blend these ingredients until homogeneous;
f. then add the whey protein crisps protein component; g. add the fiber component consisting of 50% psyllium powder and 50% Inulin; h. add the black berry powder supplement component; i. add the chia seed supplement component; i. and add the tocopherols preservative component.

31. A method of preparing a composition of claim 25 that creates a caramel flavored confection having a complete group of nutritive ingredients that when ingested synergistically affect users and promotes a feeling of fullness to support healthy weight loss and/or weight maintenance, comprises of: a. making the caramel flavored confection by adding the following ingredients together; liquid edible oil component, coconut oil component, condensed skim milk component, monosaccharide component, disaccharide component, vanilla powder component, emulsifier component, and water component; b. on low to medium heat bring the ingredients to 150 to 160 degrees Fahrenheit for 10 minutes to dissolve the sugars and emulsify the edible oils; c. then increase the heat to 225 degrees Fahrenheit and boil slowing for 15 minutes or until sufficient caramelization occurs and mixture is at correct viscosity; d. then cool to around 93 degrees Fahrenheit and add the high protein component milk protein isolate;
e. add the Inulin fiber component; f. add the antioxidant component of 100% cocoa powder; g. add the supplement I-glutamine component; and add a tocopherols natural preservative component and blend the complete mixture until homogeneous.

32. The method of claim 24 and claim 25 further comprising the step of processing said final mixture via a confectionery line into portion controlled squares or bars or bars with pre-determined breaks to control portion size. These squares or bars would be either flow wrap packaged or wrapper packaged based on the type of product being created. These wrapped confectionery products would then be packaged in secondary packaging including but not limited to bags or cartons, pop boxes, sleeves, or cardboard cases. Or the compositions could be used as an ingredient in other foods.

33. A method of creating a nutritional composition of claim 26 that can be added to foods or beverages comprises; adding the protein component, the fiber component, the edible oil component, the coconut oil component and the antioxidant component together and mix until well blended. This blended group of ingredients would then be added into the process of creating the food or beverage during the manufacturing process.

34. The method of claim 1 wherein an additional healthy nutritive ingredient can be added to create additional flavors and texture compositions including; a flavor component, a sweetener component, a color component, a preservative component, a stabilizing component, an emulsifier component, a thickening component, a filling component, a layering component, a nut component, a fruit piece component, etc. or combinations thereof to create additional flavors and varieties.
